(19) United States
(12) Patent Application Publication
(10) Pub. No.: US 2008/0181380 A1
(43) Pub. Date: Jul. 31, 2008

(54) Proxy for authenticated caller name

(75) Inventors: Christophe Gustave, Ottawa (CA); Stanley Chow, Ottawa (CA)

Correspondence Address: KRAMER & AMADO, P.C., 1725 DUKE STREET, SUITE 240, ALEXANDRIA, VA, 22314, US

(73) Assignee: ALCATEL LUCENT, Paris (FR)

(21) Appl. No.: 11/898,393

(22) Filed: Sep. 12, 2007

Related U.S. Application Data
(63) Continuation of application No. 11/699,330, filed on Jan. 30, 2007.
Application No. 11/699,330 is a continuation of application No. 11/702,555, filed on Feb. 6, 2007.

(51) Int. Cl. H04M 1/56

(52) U.S. Cl. 379/142.05

(57) ABSTRACT

A method of completing a telephone call based on an authenticated caller name proxy, and related proxy, including one or more of the following: a caller dialing the authenticated caller name proxy on behalf of a RealName entity; verifying that the RealName entity is a registered RealName entity; retrieving a list of combinations of user identifications and passwords associated with an appropriate certificate corresponding to the RealName entity; the caller providing a combination of user identification and password to the authenticated caller name proxy; determining that the combination of user identification and password provided to the authenticated caller name proxy by the caller matches an entry in the list of combinations of user identifications and passwords associated with the appropriate certificate corresponding to the RealName entity; the caller providing a called party phone number to the authenticated caller name proxy; the authenticated caller name proxy establishing an authenticated telephone call with the called party on behalf of the RealName entity using the appropriate certificate for the RealName; and means for accomplishing the same.

This is a Continuation of application Ser. No. 11/699,330 filed Jan. 30, 2007, and Ser. No. 11/702,555 filed Feb. 6, 2007. The entire disclosures of the prior applications are hereby incorporated by reference herein in their entirety.

### BACKGROUND OF THE INVENTION

1. Field of the Invention

This invention relates generally to authentication of a caller in a telephone system.

2. Description of Related Art

In computing, phishing is a typically criminal activity whereby phishers (i.e. those engaged in phishing) attempt to fraudulently acquire sensitive information, such as usernames, passwords and credit card details, by masquerading as a trustworthy entity in an electronic communication. Online Vendors, auction houses, financial transaction brokers, and banks that operate online are common targets of phishing attacks.

Phishing is typically carried out by email or instant messaging, and often directs users to give details at a website, although phone contact is also used to fraudulently obtain information. Among other data, a successful phishing attack could yield a telephone user's authentication information.

Attempts to deal with the growing number of reported phishing incidents include legislation, user training, and technical measures. Accordingly, there is a need for improved authentication of a caller in a telephone system.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

### SUMMARY OF THE INVENTION

In light of the present need for a proxy for an authenticated caller name, a brief summary of various exemplary embodiments is presented. Some simplifications and omission may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

Telephony is becoming a medium of choice for phishing attacks where phishers attempt to impersonate a third party entity, tricking phone users, thereby fraudulently gathering sensitive information from legitimate telephone users. In the same vein, voice users sometimes desire a means to unambiguously know with certainty that their calling counter part is the identity asserted for that calling party. The combination of caller ID technology and systems and methods for authenticating a caller against id spoofing, provide a reliable way to authenticate third party calling entities, with a high level of security assurance.

Typically, the implementation of the combination of the technology described above includes the caller having telephony equipment at the phone network access premises supporting the “RealName” authentication mechanism. However, it is not always possible to have this equipment in that location.

For example, when a worker travels in the course of that worker performing job duties, it might not be possible to carry telephony equipment supporting the RealName authentication mechanism outside of the premises of that worker's normal work place. Moreover, in some organizations populated with thousands of phones, it may be impractical to update each phone to support a certificate feature, especially since every employee may not use the certificate feature on a regular basis.

Accordingly, various exemplary embodiments apply and further extend certain delegation mechanisms. For example, in various exemplary embodiments, the list of authorized caller (identifier/password) associated to a certificate is further delegated to every certificate in a trusted delegation chain.

Various exemplary embodiments provide a means for authenticating caller names associated with voice-based entities registered with a caller name authentication service. Thus, various exemplary embodiments enable a caller wanting to make an authenticated call on-behalf of a pre-registered and authenticated entity, to do so using a specific code associated with the pre-registered entity and associated with a pre-registered name/password associated with the caller. Accordingly, various exemplary embodiments allow voice subscribers to ubiquitously appear as authenticated with a caller name of their choice, on a per-call basis.

Some of the subject matter incorporated herein by reference describes how appropriate certificates, such as X509 certificates, are used to positively assert the identity of a calling party in various exemplary embodiments. Sometimes, when an institution desires access to the authenticated call feature in a specific location area, the institution registers a name with the local authority managing the registry of authenticated callers for the particular area or jurisdiction.

In various exemplary embodiments, upon completion of the registration process, the institution is issued with an applicable certificate, such as an X509 certificate, embedding the name and signed by an authenticated caller name-recognized certificate authority. Phone endpoints associated with said institution are then provisioned with such certificates in various exemplary embodiments, and those are provided to the called party on a per call basis to assert the authenticity of the provided caller name in the particular jurisdiction.

Various exemplary embodiments include a mechanism for delegating the authenticated caller name feature to entities with no prior access to telephony device supporting the RealName authentication method. Thus, various exemplary embodiments include the ability for a phone user to perform an authenticated call through a dedicated proxy. In various exemplary embodiments, the authenticated caller name proxy is provisioned with a list of “RealName ID”.

In various exemplary embodiments, each RealName ID is associated with a corresponding certificate embedding a certified name for the RealName ID. In various exemplary embodiments, for each RealName ID, the proxy maintains a list of user name and password combinations. In various exemplary embodiments, each user of a list of user name and password combinations is given the capability to make a call on behalf of the associated authenticated caller name or RealName entities.

Various exemplary embodiments are non-intrusive from a handset perspective. Various exemplary embodiments are inherently simple to use and deploy. Various exemplary embodiments provide anywhere-authenticated phone calls.

### BRIEF DESCRIPTION OF THE DRAWINGS

In order to better understand various exemplary embodiments, reference is made to the accompanying drawings, wherein:

FIG. 1 is a schematic diagram of an exemplary system for caller name authentication;

FIG. 2 is a flow chart of an exemplary method for caller name authentication; and

FIG. 3 is a table of an exemplary proxy for caller name authentication.

### DETAILED DESCRIPTION OF THE PREFERRED EMBODIMENTS OF THE INVENTION

Referring now to the drawings, in which like numerals refer to like components or steps, there are disclosed broad aspects of various exemplary embodiments.

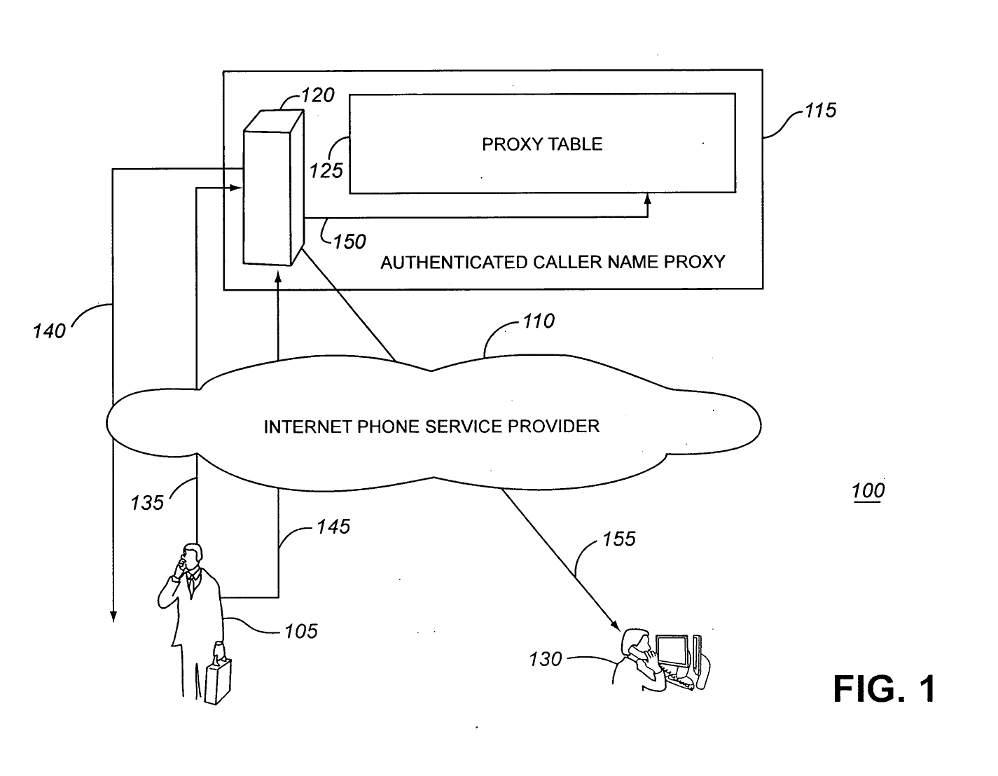

FIG. 1 is a schematic diagram of an exemplary system 100 for caller name authentication. The system 100 includes a caller 105, an Internet phone service provider 110, an authenticated caller name proxy 115 and a called party 130. The system 100 exemplifies the delegation process for caller name authentication according to various exemplary embodiments. Likewise, the system 100 illustrates the setup and authenticated call establishment handling by the proxy 115 according to various exemplary embodiments.

At the end of this exemplary process, a caller display associated with a phone of the called party 130 shows an authenticated call originating from a particular RealName associated with the authenticated caller name proxy 115. This is described in greater detail below.

Initially, the caller 105 initiates a telephone call by dialing the authenticated caller name proxy 115. This is illustrated in exemplary system 100 by line 135. As illustrated in exemplary system 100, the caller 105 dials the proxy 115 through line 135. The Internet phone service provider 110 handles this communication represented by line 135.

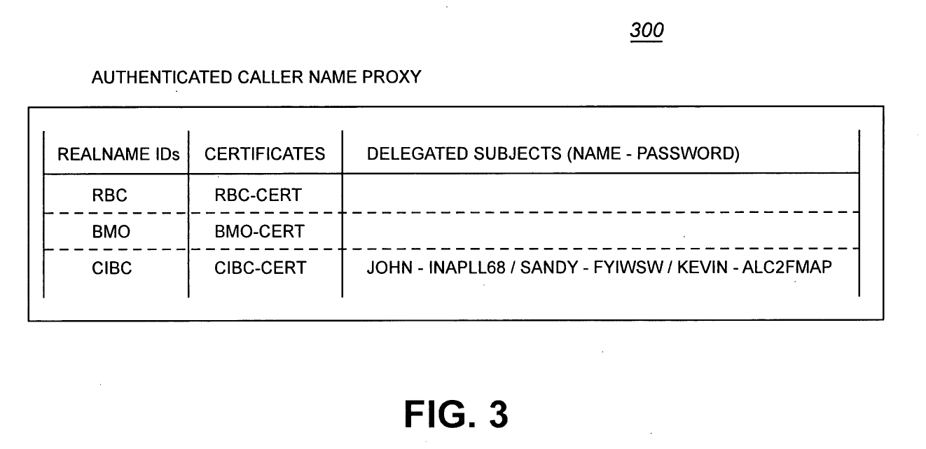

The authenticated caller name proxy 115 includes a processor 120. The processor 120 includes a proxy table 125. The proxy table 125 stores information associated with caller name authentication. The proxy table 125 will be described in greater detail below in connection with FIG. 3.

Following the caller 105 dialing the proxy 115, the proxy 115 requests a user login name and password from the caller 105. This is represented in system 100 by line 140. The communication from the proxy 115 to the caller 105 requesting a user login name and password is performed through the Internet phone service provider 110.

In response to the proxy request represented by line 140, the caller 105 sends a user name and a password to the proxy 115. This communication is represented in system 100 by line 145. Again, as with the communications represented by line 135 and line 140, the communication represented by line 145 in system 100 passes through the Internet phone service provider 110.

The proxy table 125 includes information regarding user names and passwords, among other things. After the processor 120 of the authenticated caller name proxy 115 receives the user name and password sent in the communication represented by line 145, the processor 120 fetches a delegated subjects list from the proxy table 125. This is represented in system 100 by line 150. This will also be described in greater detail below in connection with FIG. 3.

If the processor 120 authenticates the caller name when comparing the user name and password sent in the communication represented by line 145 with the corresponding information in the proxy table 125, then the processor 120 initiates an authenticated call session with the called party 130. This is represented in system 100 by line 155.

As with the communications represented by line 135, line 140 and line 145, the authenticated call session initiated by the processor 120 of the proxy 115 takes place by way of the Internet phone service provider 110. Again, as with the communication represented by line 135, the communication represented by line 145 and the fetch task represented by line 150, the proxy authenticated call session represented by line 155 in system 100 will be discussed in greater detail below in connection with FIG. 3.

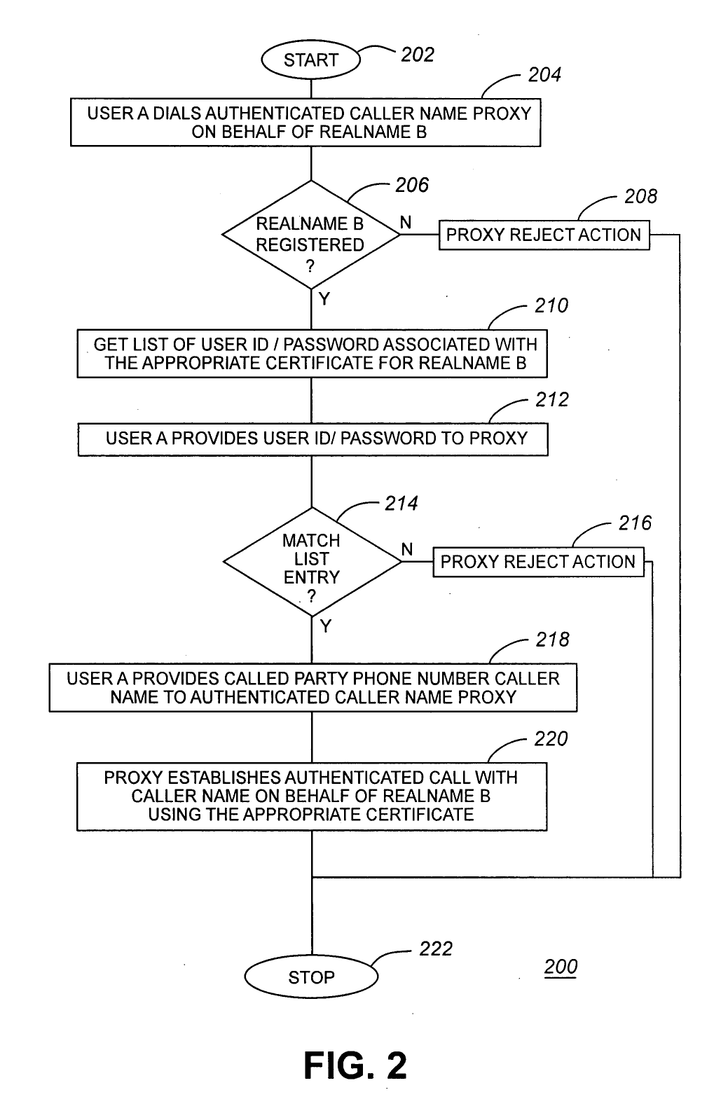

FIG. 2 is a flow chart of an exemplary method 200 for caller name authentication. Exemplary method 200 shows steps associated with the delegation of a RealName entity to a phone user such as caller 105 from an authenticated caller name proxy 115 perspective. The method 200 starts in step 202 and proceeds to step 204.

In step 204, user A dials an authenticated caller name proxy on behalf of RealName B. Thus, the caller 105 dials a telephone number associated to the authenticated caller name proxy 115. In various exemplary embodiments, the caller 105 provides an identifier of a RealName entity.

Following step 204, the method 200 proceeds to step 206. In step 206, an evaluation is performed whether the RealName B is registered. This corresponds to the action represented by line 150. In various exemplary embodiments, the proxy 115 retrieves a list of user identifications (IDs) and passwords of users associated with the RealName identifier. In various exemplary embodiments, the list of users associated with the RealName identifier is a list of users authorized to make telephone calls on behalf of the RealName entity.

When the outcome of the evaluation performed in step 206 is a conclusion that RealName B is not registered, then the method 200 proceeds to step 208. In step 208, a proxy reject action is performed. In various exemplary embodiments, the proxy reject action includes displaying a rejection message to the caller 105. In various exemplary embodiments, the rejection message is one or more of the following: “try again,” “not authorized,” and “not on the list.” Following the proxy rejection action in step 208, the method 200 proceeds to step 222 where the method 200 stops.

When a conclusion is reached in step 206 that RealName B is registered, the method 200 proceeds to step 210. In step 210, a list of user identification and password combinations associated with the appropriate certificate for RealName B is retrieved by the processor 120 from the proxy table 125. Following step 210, the method 200 proceeds to step 212.

In step 212, user A, represented as the caller 105, provides a user identification and password combination to the proxy 115. The method 200 then proceeds to step 214.

In step 214, an evaluation is performed whether the user identification and password combination provided to the proxy 115 in step 212 matches an entry on the list in the proxy table 125 for RealName B.

When a determination is made in step 214 that the user identification provided in step 212 does not appear on the list of user identifications for RealName B in the proxy table 125, then the method 200 proceeds to step 216. Similarly, when a determination is made in step 214 that the password provided for a user identification does not match the password listed in the proxy table 125 for the user identification, the method 200 proceeds to step 216.

In step 216, a proxy reject action is performed. The proxy reject action performed in step 216 is similar to the proxy reject action performed in step 208. Following the proxy reject action in step 216, the method 200 proceeds to step 222 where the method 200 stops.

When a determination is made in step 214 that the combination of user identification and password provided to the proxy 115 in step 212 matches an entry in the proxy table 125 for RealName B, then the method 200 proceeds to step 218.

In step 218, user A, represented by caller 105, provides a phone number for the called party 130. In various exemplary embodiments, the caller name is part of the certificate fetched by the authenticated caller name proxy. The method 200 then proceeds to step 220.

In step 220, the proxy 115 establishes an authenticated call with the caller name on behalf of RealName B using the appropriate certificate. This is represented in system 100 by line 155. This and other steps in exemplary method 200 will be discussed further below in connection with FIG. 3. Following step 220, the method 200 proceeds to step 222 with the method 200 stops.

According to the foregoing, in various exemplary embodiments, the caller 105 provides a valid user login in order to be able to complete a telephone call procedure to the called party 130. In various exemplary embodiments, the caller 105 provides the final destination telephone number of the actual called party 130. Various exemplary embodiments include an additional step, not shown in FIG. 2, wherein the proxy 115 checks a policy associated to RealName B and/or the identification of the caller 105 to evaluate whether the caller 105 is permitted to perform a telephone call to the called party 130 at a particular day and time when the call is initiated by the caller 105.

FIG. 3 is a table of an exemplary proxy 300 for caller name authentication. The exemplary authenticated caller name proxy 300 includes three columns. The first column is a list of RealName IDs. The second column is a list of appropriate certificates associated with the RealName IDs in the first column. The third column is a list of delegated subjects. In various exemplary embodiments, the list of delegated subjects includes combinations of user names and passwords.

In various exemplary embodiments, the appropriate certificates listed in the second column of exemplary proxy 300 are X509 certificates. In various exemplary embodiments, any other known or later developed appropriate standard is used to define the format of the appropriate certificate.

As depicted in exemplary proxy 300, the table includes three RealName IDs. Thus, proxy 300 includes three associated certificates. It should be apparent that, in various exemplary embodiments, the proxy 300 includes any number of RealName IDs including just a single RealName ID.

Likewise, the third line of the table of exemplary proxy 300 shows three delegated subjects for RealName ID CIBC. It should be apparent that, in various exemplary embodiments, any number of delegated subjects are included for any given RealName ID, including a single delegated subject. Likewise, it should be apparent that, in various exemplary embodiments, the information required to authenticate a delegated subject includes more information than a user name and a password. Likewise, it should be apparent that various exemplary embodiments include only user names but not passwords in the list of authenticated delegated subjects.

Referring again to FIG. 1, and applying the information included in exemplary authenticated caller name proxy 300, when the caller 105 dials the proxy 115 in the communication represented by line 135, the caller 105 includes an identification of RealName ID CIBC. Subsequently, when the caller 105 sends a user name and password in the communication represented by line 145, the caller 105 sends the username “Kevin” and the password “alc2fmap.”

Then, where represented by line 150, the processor 120 fetches the list of delegated subjects for RealName CIBC. This is the list in the lower right hand corner of the table for exemplary proxy 300.

The processor 120 then checks the credential for username Kevin. The processor 120 confirms that the password associated with user name Kevin under RealName CIBC is alc2fmap. Then, having confirmed a caller name authentication, the proxy 115 initiates the authenticated call session represented by line 155 to the called party 130 using the appropriate CIBC certificate found at the bottom of the second column in the exemplary proxy table 300.

According to the foregoing, various exemplary embodiments are totally seamless from a phone end point implementation perspective. Thus, various exemplary embodiments overcome a limitation of certain authenticated caller name systems in that they do not require a user wanting to leverage an authenticated caller name to have telephony equipment at the user access location supporting the applicable certificate feature. It is believed that various exemplary embodiments ubiquitously handle calls, such that those embodiments overcome the burdens associated with the set-up of the authenticated call delegation process.

It is believed that various exemplary embodiments provide a competitive edge to phone service providers empowering both their customer and enterprise users “on the go” with a reliable and user-friendly way to handle authenticated phone calls. As described above, voice phishing attacks and related threats enabling fraudulent access to sensitive data are believed to be becoming a growing concern. Both businesses and consumers may take advantage of certain exemplary embodiments described herein to mitigate phishing attacks and fraudulent access to sensitive data.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A method of completing a telephone call based on an authenticated caller name proxy, comprising:
a caller dialing the authenticated caller name proxy on behalf of a RealName entity;
verifying that the RealName entity is a registered RealName entity;
retrieving a list of combinations of user identifications and passwords associated with an appropriate certificate corresponding to the RealName entity;
the caller providing a combination of user identification and password to the authenticated caller name proxy;
determining that the combination of user identification and password provided to the authenticated caller name proxy by the caller matches an entry in the list of combinations of user identifications and passwords associated with the appropriate certificate corresponding to the RealName;
the caller providing a called party phone number to the authenticated caller name proxy; and
the authenticated caller name proxy establishing an authenticated telephone call with the called party on behalf of the RealName entity using the appropriate certificate for the RealName entity.

2. The method of completing a telephone call based on an authenticated caller name proxy, according to claim 1, further comprising showing an authenticated telephone call originating from the RealName entity on a display associated with a telephone of the called party.

3. The method of completing a telephone call based on an authenticated caller name proxy, according to claim 1, wherein the caller dials the authenticated caller name proxy on behalf of the RealName entity through an Internet phone service provider.

4. The method of completing a telephone call based on an authenticated caller name proxy, according to claim 1, wherein the RealName entity is registered with the authenticated caller name proxy.

5. The method of completing a telephone call based on an authenticated caller name proxy, according to claim 4, wherein the list of combinations of user identifications and passwords associated with the appropriate certificate corresponding to the RealName entity is obtained from a proxy table in the authenticated caller name proxy.

6. The method of completing a telephone call based on an authenticated caller name proxy, according to claim 1, further comprising the authenticated caller name proxy requesting a user login name and password combination from the caller.

7. The method of completing a telephone call based on an authenticated caller name proxy, according to claim 6, wherein the authenticated caller name proxy requests the user login name and password combination from the caller through an Internet phone service provider.

8. The method of completing a telephone call based on an authenticated caller name proxy, according to claim 1, wherein the caller provides the user identification and password combination to the authenticated caller name proxy through an Internet phone service provider.

9. The method of completing a telephone call based on an authenticated caller name proxy, according to claim 1, wherein the list of combinations user identifications and passwords associated with the appropriate certificate corresponding to the RealName entity is included in a proxy table that is part of the authenticated caller name proxy.

10. The method of completing a telephone call based on an authenticated caller name proxy, according to claim 1, wherein the caller provides the called party phone number to the authenticated caller name proxy through an Internet phone service provider.

11. The method of completing a telephone call based on an authenticated caller name proxy, according to claim 1, wherein the authenticated caller name proxy establishes the authenticated telephone call with the called party on behalf of the RealName entity using the appropriate certificate for the RealName entity through an Internet phone service provider.

12. The method of completing a telephone call based on an authenticated caller name proxy, according to claim 1, wherein the appropriate certificate is an X509 certificate.

13. The method of completing a telephone call based on an authenticated caller name proxy, according to claim 1, wherein the authenticated caller name proxy includes a proxy table associating at least one RealName entity identification with at least one corresponding appropriate certificate and at least one corresponding username.

14. The method of completing a telephone call based on an authenticated caller name proxy, according to claim 13, wherein the proxy table is stored in an electronic storage media included in a processor that is part of the authenticated caller name proxy.

15. The method of completing a telephone call based on an authenticated caller name proxy, according to claim 13, wherein the at least one corresponding username has at least one corresponding associated password.

16. The method of completing a telephone call based on an authenticated caller name proxy, according to claim 15, wherein the proxy table further includes additional authentication data associated with each of the at least one corresponding username.

17. An authenticated caller name proxy for use in completing a telephone call, comprising:
a means for receiving a communication from a caller dialing the authenticated caller name proxy on behalf of a RealName entity;
a means for determining if the RealName entity is registered;
a means for receiving a user identification and password combination provided by the caller;
a means for obtaining a list of user identification and password combinations associated with an appropriate certificate for the RealName entity;
a means for determining whether the user identification and password combination received from the caller matches an entry in the list of user identification and password combinations associated with the appropriate certificate for the RealName entity;
a means for receiving a called party phone number from the caller; and
a means for establishing an authenticated telephone call with the called party on behalf of the RealName entity using the appropriate certificate for the RealName entity.

18. The authenticated caller name proxy for use in completing a telephone call, according to claim 17, wherein the authenticated caller name proxy includes a processor.

19. The authenticated caller name proxy for use in completing a telephone call, according to claim 17, wherein the authenticated caller name proxy includes a proxy table.

20. The authenticated caller name proxy for use in completing a telephone call, according to claim 17, wherein the authenticated caller name proxy communicates with a telephone caller and a called party through an Internet phone service provider.
